(19) United States
(12) Patent Application Publication
(10) Pub. No.: US 2016/0306947 A1
(43) Pub. Date: Oct. 20, 2016

(54) METHODS, SYSTEMS, AND DEVICES FOR DESIGNING MOLECULES

(71) Applicants: DOW GLOBAL TECHNOLOGIES LLC, Midland, MI (US); THE REGENTS OF THE UNIVERSITY OF MICHIGAN, Ann Arbor, MI (US)

(72) Inventors: Ronald LARSON, Ann Arbor, MI (US); Prateek JHA, Ann Arbor, MI (US); Robert SCHMITT, Annandale, NJ (US); William PORTER, III, Midland, MI (US)

(73) Assignees: DOW GLOBAL TECHNOLOGIES LLC, Midland, MI (US); THE REGENTS OF THE UNIVERSITY OF MICHIGAN, Ann Arbor, MI (US)

(21) Appl. No.: 15/030,224

(22) PCT Filed: Oct. 23, 2014
(86) PCT No.: PCT/US2014/062023

§ 371 Date: Apr. 18, 2016

Related U.S. Application Data
(60) Provisional application No. 61/894,756, filed on Oct. 23, 2013.

(51) Int. Cl. G06F 19/00; G06F 17/18

(52) U.S. Cl. CPC G06F 19/701; G06F 17/18

(57) ABSTRACT

Method, systems, and devices for designing a test molecule are disclosed. An example method includes using a molecular simulator to generate sets of simulation data. Each set of simulation data may include simulation data indicative of simulated locations in a solvent of (i) molecules of a reference molecule and (ii) molecules of one of M test molecules. The method may also include determining a probability of contact between an a species and a β species for each set of simulated data. A contact may occur when a particle of the β species is within a range of radials distances from a particle of the α species. Each of the a species and the β species may be one of the reference molecule, the solvent, or one of the M test molecules. The method may further include determining a simulation result based on at least one probability of contact.

### CROSS-REFERENCE TO RELATED APPLICATION

Priority is claimed to U.S. Provisional Patent Application No. 61/894,756 filed on Oct. 23, 2013, the contents of which are hereby incorporated by reference.

### FIELD

This invention relates to the design of molecules, such as pharmaceutical excipients, and, more particularly, to methods, systems, and devices suitable for use in designing molecules that enhance a characteristic of a reference molecule in a given solution.

### BACKGROUND

Polymers and oligomers are commonly used as excipients in the delivery of pharmaceutical compounds. One reason for the use of polymers and oligomers is that they are multifunctional (i.e., have many substitution positions) and exhibit cooperative behavior (i.e., interactions between substituted groups) that more readily allow for interaction with drug molecules, as compared to low molecular weight compounds used as excipients. With respect to low-solubility active pharmaceutical ingredients (API), excipient polymers and oligomers can inhibit the aggregation and crystallization of APIs through non-covalent bonding or molecular interactions (such as, for example, associations, dipole interactions, hydrogen bonding, dispersion forces, hydrophilic interactions, etc.), thereby enhancing the bioavailability of the API. Given the flexibility in the design of polymers and, to some extent, of oligomers, a polymer or oligomer excipient can be designed for a specific API in order to enhance the drug release properties for a particular application.

### SUMMARY

One goal in developing a pharmaceutical product that includes a low-solubility API may be to identify excipients that improve the solubility of the API in an aqueous environment. The term “API” is conventional, denoting a compound having beneficial prophylactic and/or therapeutic properties when administered to an animal, especially humans. A “low-solubility API”, means that the drug has an aqueous solubility at physiologically relevant pH (e.g., pH 1-8) of about 0.5 mg/mL or less. The invention finds greater utility as the aqueous solubility of the drug decreases. Thus, methods of the present invention are preferred for low-solubility APIs having an aqueous solubility of less than 0.1 mg/mL or less than 0.05 mg/mL or less than 0.02 mg/mL, or even less than 0.01 mg/mL where the aqueous solubility (mg/mL) is the minimum value observed in any physiologically relevant aqueous solution (e.g., those with pH values between 1 and 8) including USP simulated gastric and intestinal buffers. The active ingredient does not need to be a low-solubility active ingredient in order to benefit from this invention, although low-solubility active ingredients represent a preferred class for use with the invention. An active ingredient that exhibits appreciable aqueous solubility in the desired environment of use may have an aqueous solubility up to 1 to 2 mg/mL, or even as high as 20 to 40 mg/mL. Useful low-solubility APIs are listed in the International Patent Application Publication No. WO 2005/115330, at pages 17-22.

When developing a pharmaceutical product, a research chemist (and/or other scientist) may conduct experiments to identify a suitable excipient or excipients for use with an API. For instance, the research chemist may attempt to identify one or more excipients that improve the bioavailability of the API by enhancing solubility, minimizing API aggregation or crystallization, and/or improving any other characteristic of the API the affects bioavailability.

Polymers and oligomers offer a number of potential benefits that may make them suitable for use as excipients in pharmaceutical product. A polymer or oligomer may inhibit the aggregation and crystallization of an API by preferentially interacting with the API. Hydrophobic polymers and oligomers may make particularly attractive excipient candidates, as a hydrophobic polymer or oligomer may significantly improve the solubility of a low-solubility API. And because of the vast number of potential substitution locations, molecular weight, and chain composition, a research chemist may be able to design a polymer or oligomer excipient specifically for a given API.

However, because of the large number of available backbones and substitution positions, a large universe of potential polymer and oligomer excipients may exist for a given API. As such, a research chemist may experiment with a number of polymer and oligomer excipients, many of which, statistically speaking, will not sufficiently improve the bioavailability of the API. Consequently, vast amounts of time and materials may be expended without identifying a polymer and oligomer excipient that can be used with the API to produce a viable pharmaceutical product.

The methods, systems, and devices disclosed herein may reduce the amount of experimental testing required in identifying excipients suitable for use with a given API by simulating molecular interactions between a reference molecule and a number of test molecules. An example may include using, by a computing device, a molecular simulator to generate M sets of simulation data, with M being a positive integer. Each of the MA sets of simulation data may include one or more samples of simulation data indicative of simulated locations of molecules of a reference molecule and molecules of a test molecule in a solvent. The example method may also include determining, for each of the M sets of simulation data, a probability of contact between an alpha (α) species and a beta (β) species to provide M probabilities of contact. A contact may occur when a particle of the β species is within a range of radial distances from a particle of the α species. In this example, each of the α species and the β species may be one of the reference molecule, the test molecule, or the solvent. The example method may further include determining a simulation result based on at least one of the M probabilities of contact, and causing a display device to display the simulation result.

In this aspect, the example method may allow a research chemist to simulate the molecular interactions in the solvent between the reference molecule and the At test molecules. This may, in turn, assist the research chemist in focusing on particular molecular structures that provide the most improvement to a characteristic of the reference molecule. For example, in a pharmaceutical application, a research chemist may be able to identify polymer and oligomer structures, or perhaps even particular polymers and oligomers, that improve the solubility of an API in an aqueous solution. The example method may also be useful for testing as an excipient system for other biologically active ingredients (e.g., vitamins and herbal or mineral supplements), as well as non-biological active ingredients (e.g., fertilizers, herbicides, or pesticides).

Accordingly, in one embodiment of the example method, the reference molecule may be an API, the M test molecules may be M polymeric or oligomeric excipients, and the solvent may be water or an organic solvent.

In another embodiment of the example method, the computing device may receive one or more inputs that include information indicative of one of the reference molecule, the M test molecules, or the solvent. The computing device may receive the one or more inputs via a user interface, such as a graphical user interface (GUI). For instance, to receive each of the M test excipients, the GUI may be configured to display a field for selecting a polymer and oligomer, a field for selecting one or more substituents, and a field for selecting a location at which each of the one or more substituents is attached to (or grafted onto) the polymer and oligomer. Non-limiting examples of polymers, oligomers, and substituents are listed further below.

In yet another example embodiment, the example method may include using the molecular simulator to provide M sets of thermodynamic equilibrium conditions prior to generating the M sets of simulation data. Each of the M sets of thermodynamic equilibrium conditions may include one or more thermodynamic equilibrium conditions for a system that includes the reference molecule, one of the M test molecules, and the solvent. The molecular simulator may also use one of the M sets of thermodynamic equilibrium conditions to generate each of the M sets of simulation data. Further, a number of molecules used by the molecular simulator to determine each of the M sets of thermodynamic equilibrium conditions may be less than a number of molecules used by the molecular simulator to generate each of the M sets of simulation data.

The step of determining the M probabilities of contact may take different forms. In one embodiment, the particle of the α species may be one of an atom, molecule, or chemical moiety of the α species. Additionally, the particle of the β species may be one of an atom, molecule, or chemical moiety of the β species.

In another embodiment, determining the M probabilities of contacts comprises determining M average radial distribution functions. Determining each of the M average radial distribution functions may include determining a radial distribution function for each of the one or more samples of simulation data included in one of the M sets of simulation data, providing one or more radial distribution functions. Each of the one or more radial distribution functions may be based on a number of particles of the β species that are within a range of radial distances from a particle of the α species. The method may also include normalizing each of the one or more radial distribution functions to provide one or more normalized radial distribution functions and averaging the one or more normalized radial distribution functions to provide the average radial distribution function.

In a further embodiment, the method may include determining a maximum value of each of the M average radial distribution functions to provide M maximum values. Each of the M maximum values may correspond to one of the M test molecules. In this aspect, the simulation result may include information indicative of (i) one or more test molecules included in the M test molecules and (ii) a maximum value associated with each of the one or more test molecules. Additionally or alternatively, the example method may include generating a table that arranges the one or more test molecules included in the M test molecules according to a maximum value associated with each of the one or more test molecules. The simulation result may include information indicative of the table.

In yet a further embodiment, the example method may include identifying a preferred test molecule from the M test molecules based on the maximum value associated with each test molecule. The simulated result may include information indicative of the M preferred molecule. For instance, if the α species and the β species are the reference molecule, the preferred test molecule may be the test molecule included in the M test molecules corresponding to the smallest maximum value. Alternatively, if at least one of the α species or the β species is one of the solvent or one of the M test molecules, the preferred test molecule may be the test molecule included in the M test molecules corresponding to the largest maximum value.

Additionally, a computing device and a system are disclosed herein that are configured to implement the example method.

### BRIEF DESCRIPTION OF THE DRAWINGS

FIG. 1 is a simplified diagram of a distributed computing architecture, in accordance with an example embodiment.

FIG. 2 is a block diagram of a computing device, in accordance with an example embodiment.

FIG. 3 is a block diagram of a server device, in accordance with an example embodiment.

FIG. 4-7 are a flow diagrams of a methods, in accordance with example embodiments.

FIGS. 8A-8B are graphs of average radial distribution functions, in accordance with example embodiments.

### DETAILED DESCRIPTION

The following detailed description describes various features, functions, and attributes of the disclosed systems, methods, and devices with reference to the accompanying figures. In the figures, similar symbols typically identify similar components, unless context dictates otherwise. The illustrative embodiments described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

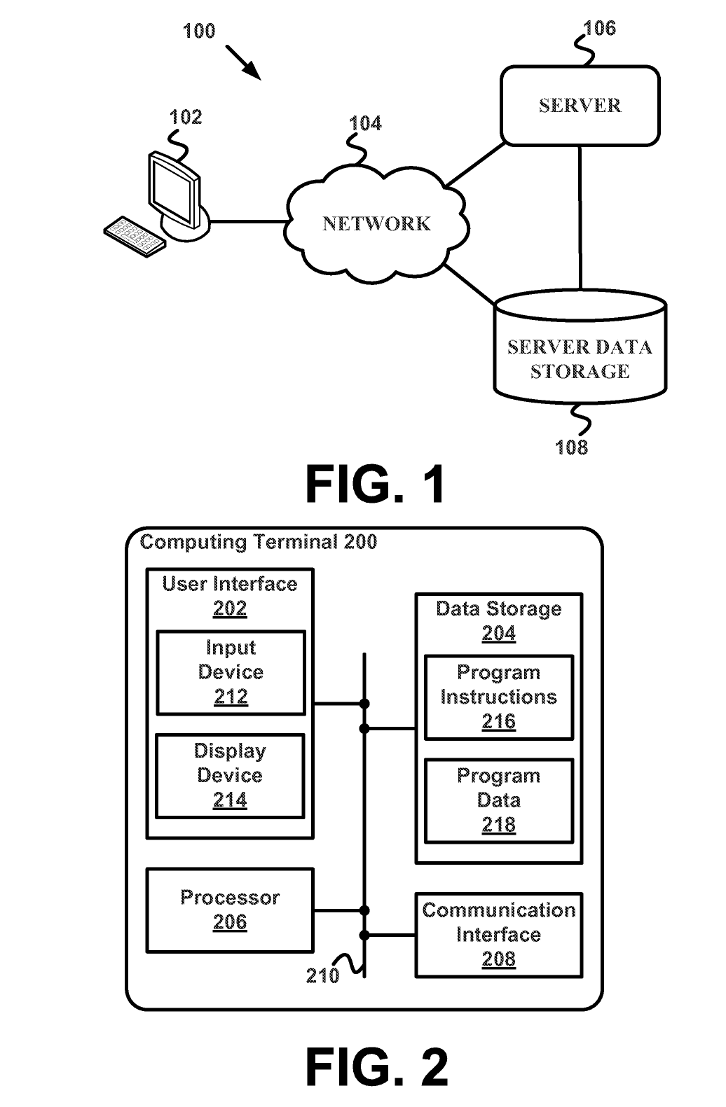

FIG. 1 is a simplified block diagram of a distributed computer architecture in which various embodiments described herein can be employed. A computing system 100 includes a computing terminal 102 that may communicate with other computing devices via a network 104. Thus, although only one computing terminal is shown in FIG. 1, the communication system 100 may include a plurality of additional computing terminals that are connected to the network 104.

The computing terminal 102 may connect to the network 104 through the use of a wired and/or wireless connection. In one example, the network 104 may be a private intranet. In another example, the network 104 may be a public network, such as the Internet. Other examples may also be possible.

The network 104 may be configured as an Internet Protocol (IP) network. Accordingly, the computing terminal 102 may communicate with other devices connected to the network 104 using packet-switching technologies. Alternatively or additionally, the network 104 may incorporate circuit-switching technologies, in which case the computing terminal 102 may communicate via circuit switching and/or packet switching.

The communication system 100 also includes a server device 106 that may also communicate with other computing devices via the network 104. In another example, the computing system 100 may include one or more server devices in addition to the server device 106. For example, the computing system 100 may include a plurality of server devices arranged as server banks or server clusters configured to share processing resources.

Depending on the application, the server device 106 may communicate with other computing devices to facilitate the use of network-based or cloud-based computing. For example, the server device 106 may communicate with the computing terminal 102 according to one or more network protocols and/or application-level protocols in order to perform a task requested by a user of the computing terminal 102.

The computing terminal 102 and the server device 106 may also access a server data storage 108 via the network 104. The server device 106 may also be directly connected to the server data storage 108, as shown in FIG. 1. Further, the computing system 100 may also include additional server data storage that is directly and/or indirectly connected to the server device 106 and/or computing terminal 102, as well as other server devices and/or computing devices included in the computing system 100 that are not shown in FIG. 1. The server data storage 108 may store application data that is used to facilitate operations of applications performed by the computing terminal 102 and/or the server device 106.

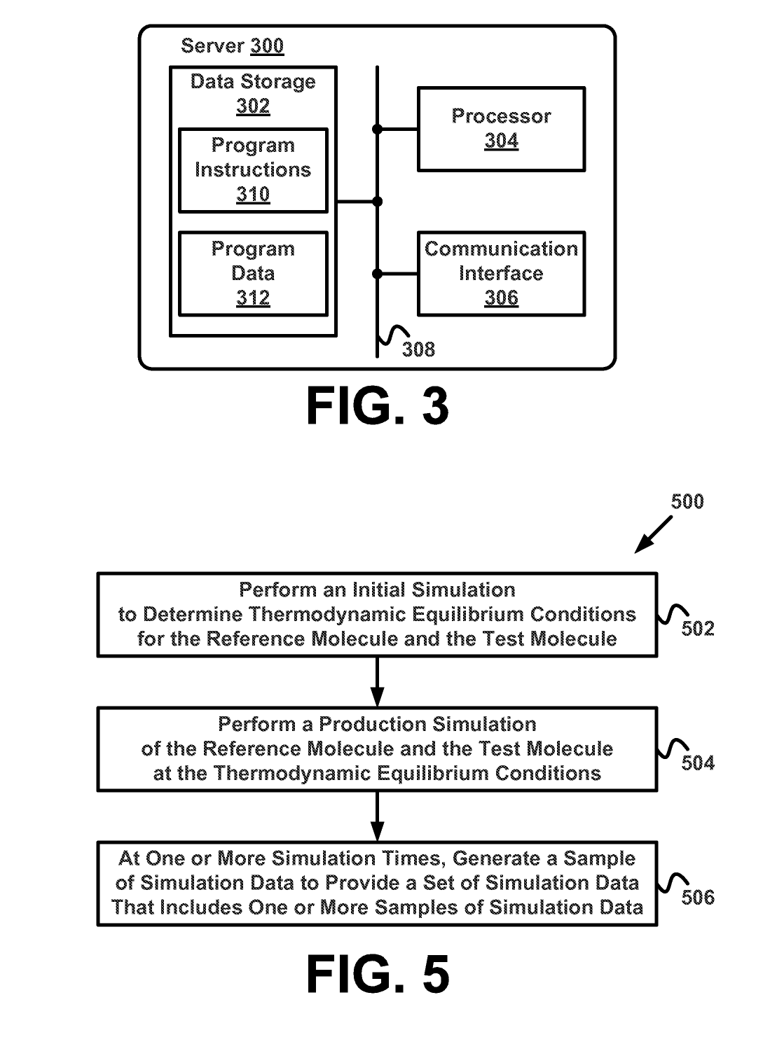

FIG. 2 is a block diagram of a computing terminal 200 in accordance with an example embodiment. The computing terminal 200 is one example of the computing terminal 102 depicted in FIG. 1. The computing terminal 200 may be a personal computing device, such as, for example, a desktop, laptop, notebook, or tablet computer.

The computing terminal 200 includes a user interface 202, a data storage 204, a processor 206, and a communication interface 208, all of which may be communicatively linked by a system bus, network, or other connection means 210.

The user interface 202 may function to allow a user to interact with the computing terminal 200. The user interface 202 may include an input device 212 and a display device 214. The input device 212 may include one or more components suitable for receiving an input from the user, such as a keyboard, a keypad, a computer mouse, and/or a trackball. The user may interact with the input device 212 to enter an input. Additionally or alternatively, the input device 212 may include a data port, such as a Universal Serial Bus (USB) port. In this example, the input device 212 may receive the input, or other information, from a portable USB storage device inserted into the USB port. The input device 212 may receive the input and generate an input signal, which may then be sent to another component of the computing terminal 200, such as the processor 206.

The display device 214 may include one or more components suitable for generating a visual output, such as a cathode ray tube display, liquid crystal display, light emitting diode display, the display using digital light processing technology, a printer, and/or any other device suitable for visually displaying information that is now known or later developed. The display device 214 may receive an output signal from a component of the computing terminal 200, such as the processor 206. The display device 214 may then generate a visual output that is displayed to the user, thereby presenting the user with a visual representation of information included in the output signal.

In one example, the input device 212 and the display device 214 may be combined into a single device, such as a touch-sensitive or pressure-sensitive display screen. Other examples may also be possible.

The data storage 204 may include any type of non-transitory, tangible, computer-readable media now known or later developed that is configurable to store program instructions 216 executable by a component of the computing terminal 200, such as a processor 206. The data storage 204 may also store other program data 218 associated with the computing terminal 200. By way of example, the program instructions 216 may include an operating system and one or more application programs installed on the computing terminal 200. The program data 218 may include operating system data and application data accessible by a component of the computing terminal 200 in order to execute program code associated with the operating system and an application program, respectively.

The processor 206 may include one or more general purpose processors (e.g., one or more microprocessors) and/or one or more special purpose processors (e.g., one or more digital signal processors, graphics processing units, floating point units, network processors, and/or application-specific integrated circuits).

The processor 206 may receive and process the input signal from the input device 212. The processor 206 may also receive and process an incoming signal from the communication interface 208. Processing the input signal and/or the incoming signal may cause the processor 206 to execute program instructions 216 by accessing the data storage 204. Executing the program instructions 216 may cause the processor 206 to read and/or write data to the program data 218, generate and send an output signal to the display device 214, and/or generate and send an outgoing signal to the communication interface 208.

The communication interface 208 may allow the computing terminal 200 to communicate with other computing devices via one or more networks, such as the network 104 depicted in FIG. 1. For example, communication interface 208 may allow computing terminal 200 to communicate with the server device 106 and/or to access the server data storage 108. Thus, the communication interface 208 may include components suitable for communicating via a circuit-switched and/or packet-switched network. The communication interface 208 may also include components suitable for connecting the computing terminal 200 to one or more networks via a wired and/or wireless connection.

The communication interface 208 may receive the incoming signal from another device via the one or more networks. The communication interface 208 may then send the incoming signal to the processor 206. The communication interface 208 may also receive outgoing signal from the processor 206 and send the outgoing signal to one or more additional devices via the one or more networks.

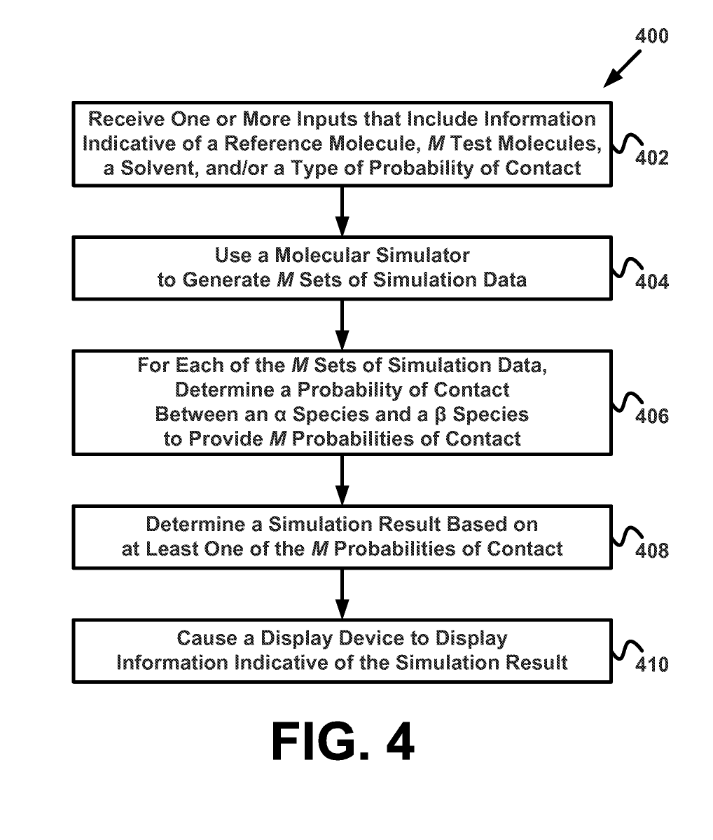

FIG. 3 is a block diagram of a server 300 according to an example embodiment. The server 300 is one example of the server device 106 depicted in FIG. 1. The server 300 may include a data storage 302, a processor 304, and a communication interface 306, all of which may be communicatively linked by a system bus, network, or other connection means 308.

The data storage 302, the processor 304, and the communication interface 306 may be the same as or substantially similar to the data storage 204, the processor 206, and the communication interface 208 described with respect to FIG. 2, respectively. Similarly, the data storage 302 may include program instructions 310 and program data 312 that are the same as or are substantially similar to the program instructions 216 and the program data 218 described with respect to FIG. 2, respectively.

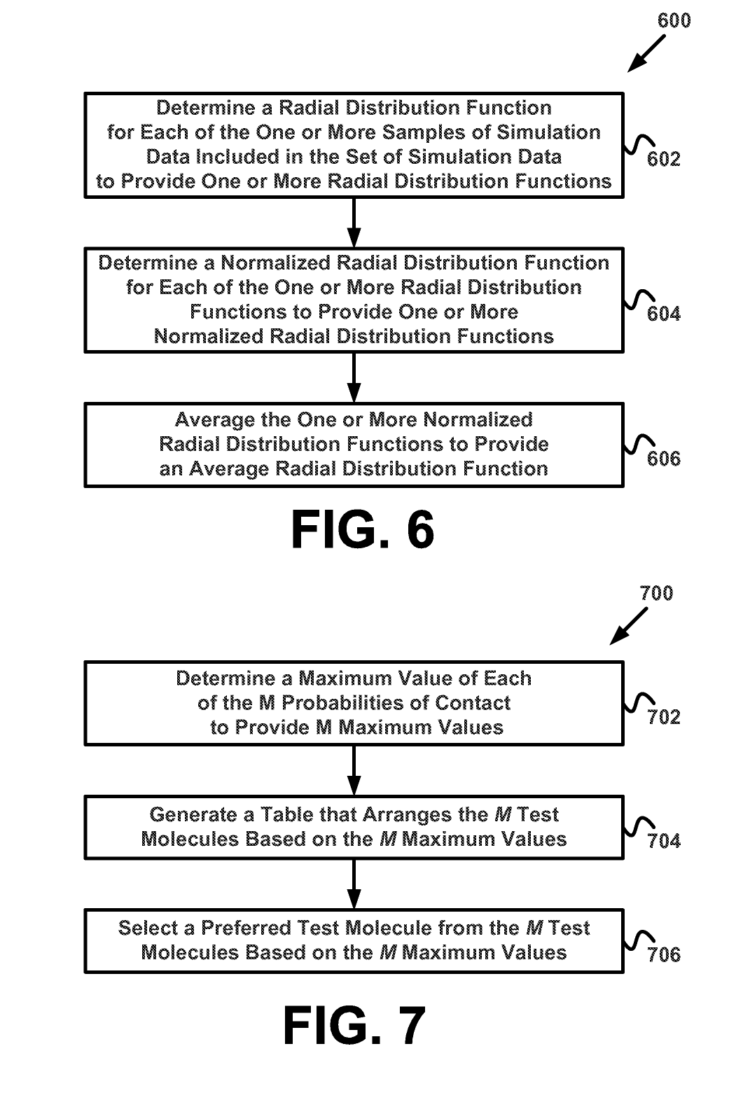

FIG. 4 is a block diagram of a method 400. A computing device, such as one or more of the computing devices depicted in FIGS. 1-3, may employ the method 400 to determine a simulation result based on simulations of molecular interactions in a solvent system between a reference molecule and one or more test molecules.

At block 402, the method 400 includes receiving one or more inputs that include information indicative of a reference molecule, M test molecules, a solvent, and/or a type of probability of contact. In one example, the computing device may cause a display device to display a graphical user interface (GUI). The GUI may include fields for selecting the reference molecule, M test molecules, a solvent, and/or a type of probability of contact. In another example, the computing device may receive the one or more inputs via a different user interface, such as, for example, via a command line instruction. In yet another example, the computing device may receive the one or more inputs via any hardware component and/or software interface now known or later developed. Thus, although the method 400 and other methods are described with respect to receiving the one or more inputs via a GUI, it understood that other examples are also possible.

The user may select the reference molecule from a reference molecule field included on the GUI. In one example, the reference molecule field may include a text box in which the user enters the chemical formula for the reference molecule. In another example, the reference molecule field may include a drop-down menu (or a similar presentation) of one or more predetermined reference molecules. The identity of the one or more predetermined reference molecules may be stored, for example, in an internal data storage of the computing device or an external source to which the computing device is connected, such as server data storage or a portable storage device.

The user may interact with the GUI to design the M test molecules. For each of the M test molecules, the user may select a polymer or oligomer, perhaps from a drop-down menu that lists a number of potential polymers and oligomers. The GUI may also allow the user to select one or more substituents to attach to (or graft onto) the polymer or oligomer at one or more locations on the polymer or oligomer. In this way, the GUI may allow the user to design multiple test molecules that can be comparatively evaluated based on their respective interactions with the reference molecule in a simulated environment. Alternatively, the polymer and/oligomer fields and/or one or more substituent fields may include a text field in which the user can enter a chemical formula for one of the M test molecules.

Potential polymers may include, but are not limited to: polysaccharides, gelatins, polyvinylpyrrolidone, poly(amino acids), such as poly(aspartic acid) or poly(glutamic acid); polylactic acid or salts of such polymerized acid; or synthetic polymers selected from the group consisting of polyalkylene oxides, such as ethylene oxide homo- and copolymers, polyethylene glycols, such as homopolymers and copolymers (including block copolymers), comprising in polymerized form an alkylene oxide, such as an ethylene oxide or a propylene oxide; an unsaturated acid or a salt thereof, such as acrylic acid, methacrylic acid, or a salt thereof; an unsaturated amide, such as acrylamide; a vinyl ester; a vinylalcohol; an acetate, such as vinylacetate; an alkylene imine, such as ethylene imine; an oxyethylene alkylether, a vinylpyrrolidone, vinyloxazolidone, vinylmethyloxazolidone, ethylene sulfonic acid, a vinylamine, vinylpyridine, or an ethylenically unsaturated sulfate or sulfonate. Exemplary of polysaccharides are starches natural gums comprising a polysaccharide hydrocolloid containing mannose repeating units, carrageenans, gum arabic, xanthan gum, gum karaya, gum tragacanth, gum ghatti, carrageenan, dextran, alginates, agar, gellan gum, such pectins, starches, starch derivatives, guar derivatives particularly, celluloses. For the purpose of the present invention, a polymer typically contains at least 50 repeat units, and, more typically, at least 100 repeat units.

Potential oligomers may include, but are not limited to, polyethylene glycols and cyclodextrans. For the purpose of the present invention a polymer typically contains from 4 to less than 50, more typically from 6 to 20 repeat units.

One type of potential substituents includes monomeric groups that include, but are not limited to: alkyl groups, such as C₁₋₃-alkyl groups (like methyl, ethyl or propyl); hydroxyalkyl groups, such as hydroxy-C₂₋₄-alkyl groups (like hydroxyethyl, hydroxypropyl, or hydroxybutyl); long-chain branched and unbranched alkyl groups, alkyl aryl groups or aryl alkyl groups having 6 or more carbon atoms; acyl groups, such as acetate, propionate, butyrate, succinate, phthalate, maleate, trimellitate or lactate groups; cationic groups, such as carboxy-C₁-C₃-alkyl (like carboxymethyl), succinate, phthalate, maleate or trimellitate.

Other potential substituents include oligomeric and polymeric groups that are capable of being grafted onto another polymer or oligomer, such as polyethylene oxides or polyvinylacetates. As another example, polyethylene glycols (“PEGs”), which generally refer to oligomers and polymers of ethylene oxide with a molecular mass below 20,000 Daltons, may be another class of substituents. The GUI may allow the user to covalently graft one or more PEGs to another polymer or oligomer by pegylation. Further, the one or more PEGs may have different geometries, which may affect the locations at which the one or more PEGs may be attached to (or grafted onto) to form the excipient. For instance, a branched PEG or a star PEG may have one or more PEG chains emanating from a central core group or molecule, and/or a comb PEG may have multiple PEG chains that can be grafted onto another polymer or oligomer. Other examples of polymeric or oligomeric substituents are also possible,

The substituents replace a hydrogen atom, such as an alkyl hydrogen, a hydroxy hydrogen or an amine hydrogen in the polymer or oligomer. The available substituents and the available locations for attachment may depend on the selected polymer or oligomer. For example, if the polymer is polyvinylpyrrolidone, the GUI may allow the user to select one of a plurality of substituents to replace an alkyl hydrogen on the polymer chain or on the pyrrolidone ring. Another possibility may be to replace the polyvinylpyrrolidone alkyl hydrogen with a grafted polyvinylacetate.

As another example, if the polymer or oligomer is a cellulose or cyclodextrin, then any number of substituents may be attached to the polymer or oligomer through ether or ester linkages at the 2, 3, and 6 positions of the D-glucopyranose units. As such, there may be multiple possible repeat units N, where the number of repeat units possible is dependent on the number of unique, non-hydrogen substituents, n. For example, the following equation defines the number of unique repeating units that can occur for a solubility enhancing excipient with a cellulosic polymer with n unique substituents:

N=(2)³ⁿ=8ⁿ

The available substituents and the available locations for attachment may depend on the selected polymer or oligomer. Polyethylene oxides are one example class of substituents that the user may be able to attach to a vinyl polymer. Additionally or alternatively, an appropriate side chain comprising a polyethylene oxide may be grafted onto a polymer.

The user may also select a number of molecules of the reference molecule and M test molecules. In one example, the user may select a specific number of molecules for the reference molecule and for each of the M test molecules. In another example, the user may select, for each of the M test molecules, a ratio of molecules of the reference molecule to molecules of the test molecule. In yet another example, the user may select a concentration of the reference molecule and each of the M test molecules in the solvent system, perhaps by weight percentages. And other examples for selecting the number of molecules of the reference molecule and each of the M test molecules may be possible as well.

The user may select the solvent from a solvent field. In one example, the solvent field may include a text box in which the user enters the chemical formula for the reference molecule. In another example, the solvent field may include a drop-down menu or similar presentation of one or more predetermined solvents. The one or more predetermined solvents may be stored in a same or substantially similar manner as the one or more predetermined reference molecules. Alternatively, the user may not select a solvent. In this example, a default solvent, such as water, may be included in the one or more inputs.

The user may select the solvent from a wide field of organic and aqueous solvents. Typical solvents are water and polar organic solvents having one or more heteroatoms, such as oxygen, nitrogen or halogen like chlorine. Typical organic solvents are alcohols, for example multifunctional alcohols, such as propylene glycol, polyethylene glycols, polypropylene glycols or glycerol; or monofunctional alcohols, such as methanol, ethanol, isopropanol or n-propanol; ethers, such as tetrahydrofuran, ketones, such as acetone, methyl ethyl ketone, or methyl isobutyl ketone; acetates, such as ethyl acetate; halogenated hydrocarbons, such as methylene chloride; or nitriles, such as acetonitrile. Typically the organic solvents have 1 to 6, more typically 1 to 4 carbon atoms.

The user may select the type of probability of contact from a probability of contact field. In one example, the user selects from the one of the following types of probabilities of contact: reference molecule-reference molecule, reference molecule-test molecule, reference molecule-solvent, and/or test molecule-solvent. Additionally, the user may select more than one type of probability of contact. If the user does not select a type of probability of contact, a default type of probability of contact, such as, perhaps, the reference molecule-test molecule type, may be included in the one or more inputs.

In further embodiments, the user may select additional fields via the GUI. The user may select a bin width (δr) used to determine one or more probabilities of contacts. The user may select a δr such that the δr is small enough to account for spatial variations in molecular pairs (e.g., particles of the α species paired with particles of the β species) while being large enough to obtain a sufficiently smooth distribution of a probability of contact. In one example, the user may select a δr for each of the M test molecules. In another example the user may select one δr that is used for more than one of the M test molecules. Alternatively, the computing device may be configured to select the δr for one or more of M test molecules based on, perhaps, the reference molecule and/or the M test molecules.

Alternatively or additionally, the user may store information indicative of one of the reference molecule, the M test molecules, the solvent, and/or the type of probability of contact on a portable memory device, such as a portable Universal Serial Bus (USB) drive. The user may insert the USB drive into a USB port included in the user interface of the computing device, and the computing device may receive the one or more inputs from the USB drive. Alternatively or additionally, the processor may receive the one or more inputs from a remote computing device connected to the computing device via a wired or wireless connection, such as, perhaps, through a computing network 104.

At block 404, the method 400 includes using a molecular simulator to generate M sets of simulation data. The molecular simulator may employ any algorithm, method, process, or technique now known or later developed to simulate molecular force-fields of a system. In one example, the molecular simulator may employ a molecular dynamics model to simulate the system. In another example, the molecular simulator may use a Metropolis Monte Carlo model to simulate the system. Other examples may also be possible.

The molecular simulator may generate a set of simulation data for simulations of the molecular interactions in the solvent system between the reference molecule and each of the M test molecules to provide M sets of simulation data. An example method for determining each of the M sets of simulation data is described with respect to FIG. 5.

At block 406, the method 400 includes determining, for each of the M sets of simulation data, a probability of contact between an α species and a β species result to provide M probabilities of contact. An identity of each of the α species and the β species may depend on the type of probability of contact. As one example, the following table may define the α species and the β species based on the type of probability of contact:

| Type of Probability of Contact | α Species | β species |
|---|---|---|
| Reference molecule-Test molecule | Reference | Test molecule |
| | molecule | |
| Reference molecule-Reference molecule | Reference | Reference |
| | molecule | molecule |
| Reference molecule-Solvent | Reference | Solvent |
| | molecule | |
| Test molecule-Solvent | Test molecule | Solvent |

Other types of probabilities of contact may also be possible.

In one example, the computing device determines the probability of contact based on the selected type of probability of contact received from the user via the GUI. Alternatively, the computing device may determine the M probabilities of contact for one or more, or perhaps all, of the types of probabilities of contact. An example method for determining a probability of contact for each of the M sets of simulation data is described with respect to FIG. 6.

At block 408, the method 400 includes determining a simulation result based on at least one of the M probabilities of contact. In one example, the simulation result may include information indicative of the M probabilities of contact. In another example, the simulation result may be a Fourier transform of each of one or more of the M probabilities of contact. In this example, the computing may determine a Fourier transform of each probability of contact, and include each Fourier transform in the simulated result.

In another example, the simulation result may include information usable for comparing the M test molecules, such as, perhaps, a table or listing of the M solutes based on a probability of contact associated with each of the M test molecules. In another embodiment, the simulation result is the identity of a preferred test molecule selected from the M test molecules based on the table and/or the M probabilities of contact. Other examples may also be possible. An example method for determining the simulation result is described with respect to FIG. 7.

At block 410, the method 400 includes causing a display device to display information indicative of the result. In one example, the computing device may cause the display device to display information indicative of the simulation result on the GUI. The information indicative the result may include one or more of a table, a graph, text, and/or any other suitable presentation of the simulated result.

The user may also interact with the GUI to select a desired display of the information indicative of the simulation result. For instance, the user may interact with the GUI to select a table of the M test molecules and probabilities of contact and/or a preferred test molecule. The computing device may also be configured to display information indicative of one or more sets of simulation data, perhaps in response to an additional input received from the user interacting with the GUI.

In FIG. 4, the blocks of the method 400 are described as being performed sequentially. In one example, the computing device may simultaneous perform the steps of one or more of the blocks of the method 400. For instance, the computing device may perform portions of two or more of blocks 404-408 simultaneously. Other examples may also be possible.

FIG. 5 is a flow diagram of a method 500. A computing device may perform the steps of one or more blocks of the method 500 to generate a set of simulation data using a molecular simulator. The method 500 is one example of a method that a computing device may employ when performing the steps of block 404 of the method 400. That is, the computing device may perform the method 500 to determine a set of simulation data for each of the M test molecules.

When performing the simulations described with respect to the method 500, the computing device may use one or more simulations engines. The simulation engines may be any simulation engine now known or later developed that is suitable for simulating the molecular interactions between a reference molecule and a test molecule.

As previously explained, the reference molecule may be a polymer or an oligomer. When performing the simulations described herein, the computing device may use fragments of the test molecule, with each fragment including about four to five monomer units of the test molecule. In another example, the computing device may use longer or shorter fragments of the test molecule. For instance, the length of the test molecule may be a multiple of the length of the reference molecule. As one example, the length of the test molecule may be four to five times the length of the reference molecule. Other example multiples are also possible.

At block 502, the method 500 includes performing an initial simulation to determine thermodynamic equilibrium conditions for the reference molecule and the test molecule. In one example, the thermodynamic equilibrium conditions may include, for instance, an equilibrium temperature, an equilibration time, an equilibrium pressure, and/or an equilibrium density of the reference molecule and/or the test molecule in a solution volume. In another example, the thermodynamic equilibrium conditions may include other and/or additional conditions.

The computing device may use the molecular simulator to determine the thermodynamic equilibrium conditions for the reference molecule and the test molecule. In one example, the molecular simulator may evaluate the energies for a small number of molecules of the reference molecule and the test molecule when performing the initial simulation, perhaps as few as one to five percent of the total number of molecules of the reference molecule and molecules of the test molecules. Other example quantities of the reference molecule and the test molecule may also be possible.

At block 504, the method 500 includes performing a production simulation of the reference molecule and the test molecule at the thermodynamic equilibrium conditions. In general, a production simulation of the reference molecule and the test molecule may include evaluating the molecular interactions between a greater number of molecules of the reference molecule and test molecule. In this manner, the molecular simulator may generate significantly more data that can be used to evaluate the molecule interactions between the reference molecule and the test molecule.

At block 506, the method 500 includes generating, at one or more simulation times, a sample of simulation data to provide a set of simulation data that includes one or more samples of simulation data. Each sample of simulation data may, at each simulation time, include information indicative of locations of a plurality of molecules (i.e., the simulated three-dimensional position and orientation of a molecule in the solution) of each of the reference molecule and the test molecule.

In one example, a fixed time interval may separate each of the one or more simulation times. In another example data during the production simulation, with the time between each successive simulation time being random. For example, the computing device may take, at random, five hundred samples of simulation data during the production simulation. Other examples are also possible.

FIG. 6 is a flow diagram of a method 600. A computing device may perform the steps of one or more of blocks of the method 600 to determine a probability of contact between two species of molecules based on a set of simulation data. The method 600 is one example of a method that a computing device may perform when performing the steps of block 406 of the method 400. That is, the computing device may perform the steps of the method 400 to determine a probability of contact for each of the M sets of simulation data in order to provide the M probabilities of contact.

At block 602, the method 600 includes determining a plurality of radial distribution functions for each of the one or more samples of simulation data included in the set of simulation data to provide one or more radial distribution functions. To determine a radial distribution function, which may be represented as g_{αβ}(r), the computing device may determine a number of particles of the β species within a range of radial distances (r) from each particle of the α species. For each of the α species and the β species, the particles may be an atom, molecule, or chemical moiety of the respective species. The range of radial distances may depend on δr. In one example, the range of radial distances may be r−δr/2 to r+δr/2. Other examples may also be possible. The computing device may determine a radial distribution function for each sample of the simulation data included in the set of simulation data.

At block 604, the method 600 includes determining a normalized radial distribution function for each of the one or more radial distribution functions to provide one or more normalized radial distribution functions. The computing device may normalize each of the one or more radial distribution functions using any suitable method, algorithm, process, or procedure now known or later developed. In one example, the computing device may use the following equation to normalize each radial distribution function:

$$\overline{{g}_{α β} ( r )} = \frac{{g}_{α β} ( r )}{{X}_{α} ( {ρ}_{β} {V}_{δ r} )}$$

where X_{α} is a number of atoms (or molecules) of the α species, ρ_{β} is an average density of molecules of the β species, and V_{δr} is the volume of a spherical shell between the radial distances r−δr/2 and r+δr/2.

At block 606, the method 600 includes averaging the normalized radial distribution functions to provide an average radial distribution function. The average radial distribution function for the set of simulation data may be the probability of contact for the test molecule used to generate the set of simulation data. In one example, the computing device may use each normalized radial distribution function included in the plurality of normalized radial distribution functions to provide the average radial distribution function. In another example, the computing device may use a subset of the one or more radial distribution functions to provide the average radial distribution function.

FIG. 7 is a flow diagram of a method 700. A computing device may perform the steps of one or more blocks of the method 700 to determine a simulation result. The method 700 in one example of a method a computing device may perform when performing the steps of block 408 of the method 400. That is, the computing device may perform the steps of the method 700 to determine a stimulation result based on at least one of the M probabilities of contact.

At block 702, the method 700 includes determining a maximum value of each of the M average probabilities of contact to provide M maximum values. In an example in which a probability of contact is defined as an average radial distribution function, the maximum value of the probability of contact is the value of the maximum peak of the average radial distribution function. In another example, the probability of contact may be defined by another radial distribution function. In this example, the maximum peak value of the radial distribution function may be the maximum value of the probability of contact. Other examples may also be possible.

At block 704, the method 700 includes generating a table that arranges the M test molecules based on the M maximum values. Each maximum value corresponds to one of the M test molecules (e.g., the test molecule used to generate the set of simulation data from which the probability of contact was determined). The computing device may generate the table by arranging one or more test molecules according to the maximum value corresponding to the one or more test molecules. Whether the one or more test molecules arranged in ascending or descending order may depend on the type of probability of contact used to the determine the M probabilities of contact.

In one example, the computing device may use the reference molecule-reference molecule type of probability of contact. In this example, the computing device may generate the table by arranging one or more of the M test molecules in ascending order (e.g., the computing device may arrange the one or more AlM test molecules from least maximum value to greatest maximum value).

In the context of a pharmaceutical application, a research chemist may use the reference molecule-reference molecule type of probability of contact to evaluate the effectiveness of excipients (i.e., test molecules) in inhibiting the aggregation of an API (i.e., reference molecule) in a solvent system (e.g., aqueous environment). If an excipient results in a lower maximum value of a probability of contact, in comparison to maximum values of other probabilities of contact, then the research chemist may determine that the excipient is more effective at inhibiting the aggregation of the API than other excipients. Arranging the one or more excipients according their corresponding maximum values in ascending order may thus allow the user to quickly identify the excipient(s) that are more effective at inhibiting aggregation of the API.

In another example, the computing device may use a different type of probability of contact when generating the M probabilities of contact, such as a reference molecule-test molecule probability of contact, a reference molecule-solvent probability of contact, or a solute-solvent probability of contact. In this example, the computing device may arrange one or more of the M test molecules in descending order (e.g., the computing device may arrange the one or more test molecules from greatest maximum value to least maximum value).

In the context of a pharmaceutical application, a research chemist may use the reference molecule-test molecule type of probability of contact to assess the effect of excipients in improving the solubility of the API in an aqueous environment. If an excipient results in a greater maximum value, as compared to maximum values of other probabilities of contact, the research chemist may determine that the excipient is more effective in enhancing the solubility of the API than other excipients. Arranging the one or more excipients according their corresponding maximum values in descending order may thus allow the user to quickly identify the excipient(s) that are more effective at enhancing the solubility of the API.

Similarly, a research chemist may use the reference molecule-solvent or test molecule-solvent types of probabilities of contact to assess the effectiveness of excipients on the solubility of an API in the solvent, e.g., in an aqueous environment. As with the previous example, a greater maximum value of a probability of contact may inform the research chemist that an excipient is more effective at improving the solubility of the API than other excipients. Arranging the one or more excipients according their corresponding maximum values in descending order may thus allow the user to quickly identify the excipient(s) that are more effective at enhancing the solubility of the API. Additionally, the research chemist may be able to evaluate the simulation conditions by comparing the maximum values of successive simulations. If two maximum values for the same excipient are not within a statistical error, the research chemist, or perhaps the computing device, may determine that the simulations are not being conducted at thermodynamic equilibrium conditions. In response, the research chemist (or the computing device) may adjust one or more simulation parameters (e.g., δr, time of the equilibration simulation, or time of the production simulation, sample size, or sampling frequency during production simulations) used by the molecular simulator.

At block 706, the method 700 includes selecting a preferred test molecule from the M test molecules based on the M maximum values. The preferred test molecule may depend on the type of probability of contact used to generate the M probabilities of contact. For instance, if both the α species and the β species are the reference molecule, the computing device may select as the preferred test molecule the test molecule corresponding to the lowest maximum value. In another example, such as when at least one of the α species and the β species is one of the test molecule or the solvent, the computing device may select as the preferred test molecule the solute corresponding to the highest maximum value. In yet other examples, other criteria may be used to select the preferred test molecule.

To illustrate the operation of a computing device configured to implement the described methods, consider the following examples. Although these examples are described with respect to a pharmaceutical application, it is understood that the computing device may implement the described methods in other applications.

In performing the steps of block 402, the computing device may receive inputs indicative of an API and three test excipients: excipient A, excipient B, and excipient C. The computing device may also receive an input (perhaps by default) indicating that the solvent is water. The computing device may also receive an input identifying a type of probability of contact.

In performing the steps of block 404 and the method 500, the computing device may generate three sets of simulation data, each of which is generated from simulations of molecular interaction in an aqueous solution between the API and one of the excipients. Each set of simulation data may correspond to the excipient from which the set of simulation data was generated. That is, a first set of simulation data may correspond to excipient A, a second set of simulation data may correspond to excipient B, and a third set of simulation data may correspond to excipient C.

In performing the steps of block 406 and the method 600, the computing device may perform determine three probabilities of contact. The computing device may determine each probability of contact as an average radial distribution function determined from one of the three sets of simulation data.

In performing the steps of block 408 and/or the method 700, the computing device may determine a simulation result based on the three probabilities of contact. The computing device may determine a maximum value of each probability of contact based on a maximum peak of the average radial distribution function. For illustrative purposes, MV_{A} may be a maximum value of the probability of contact corresponding to the excipient A, MV_{B} may be a maximum value of the probability of contact for corresponding to excipient B, MV_{C} may be the maximum value of the probability of contact corresponding to excipient C. Additionally, MV_{A} may be greater than MV_{B} and MV_{B} may be greater than MV_{C}.

The computing device may generate a table that arranges the three excipients according to their corresponding maximum values. As described with respect to block 704, how the computing device generates the table may depend on the selected type of probability of contact. In an example in which the type of probability of contact is the reference molecule-reference molecule (e.g., API-API) type, the computing device may arrange the three excipients according to their respective maximum values in ascending order. That is, that computing device may generate the table such that excipient C is in a first row, excipient B is in a second row, and excipient A is in a third row. Additionally, the computing device may identify excipient C as the preferred test molecule.

In an example in which the type of probability of contact is not the reference molecule-reference molecule type, the computing device may arrange the three excipients according to their respective maximum values in descending order. That is, the computing device may generate the table such that excipient A is in the first row, excipient B is in the second row, and excipient C is in the third row. Additionally, the computing device may identify excipient A as the preferred test molecule.

As an additional example, consider the following pharmaceutical application where the reference molecule is a low-solubility API. In this example, the user may interact with the GUI to select Phenytoin (IUPAC name: 5,5-diphenylimidazolidine-2.4-dione) as the API (i.e., reference molecule). The user may also interact with the GUI to select two excipients (i.e., test molecules). The first excipient is cellulose derivative hydroxypropylmethycellulose acetate with molar degrees of substitution of 2.0 methyl, 0.2 hydroxypropyl, and 0.8 acetate. The second excipient is hydroxypropylmethylcellulose succinate with molar degrees of substitution of 2.0 methyl, 0.2 hydroxypropyl, and 0.8 succinate. The user may also interact with the GUI to select water as the solvent and to select concentrations by weight percentages of the reference molecule and each of the test molecules in an aqueous API-excipient dispersion as 10% and 3.3%, respectively.

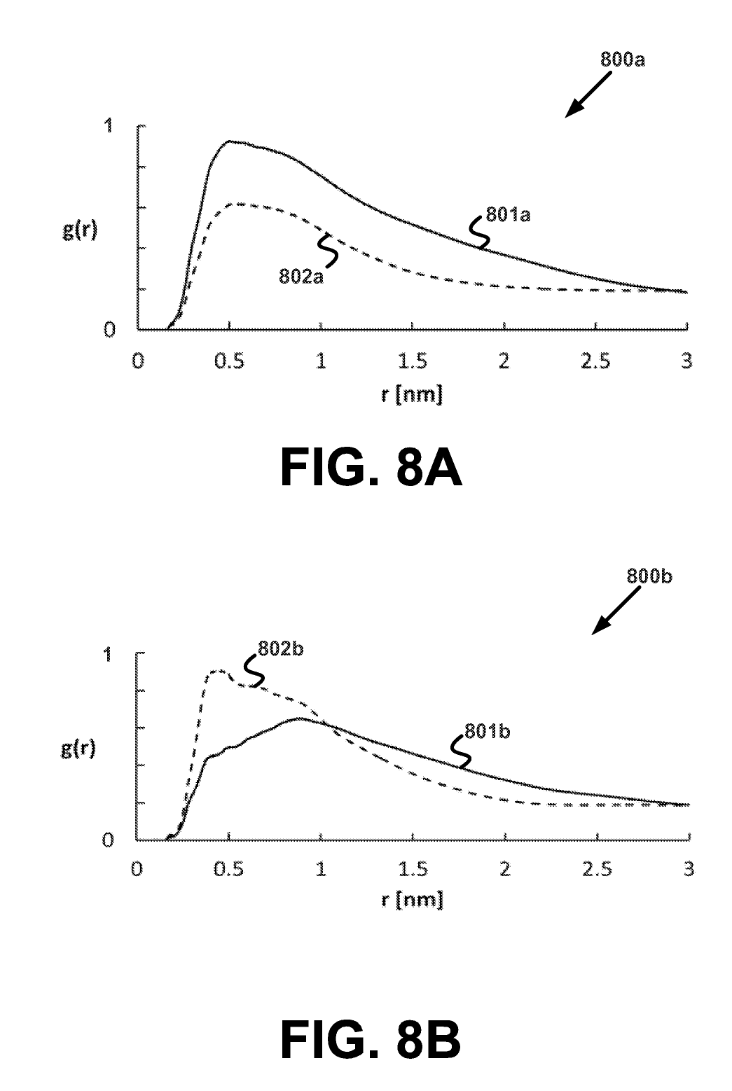

The computing device may then perform the steps of the methods 400, 500, 600, and 700 to simulate the molecular interactions between Phenytoin and the two excipients. FIGS. 8A and 8B are graphs of example average radial distribution functions that the computing device may generate at step 606 of the method 600. More specifically, FIG. 8A is a graph 800a of API-excipient average radial distribution functions between the API and each of the excipients. A first curve 801a represents a first API-excipient average radial distribution function for the simulation of the API and the first excipient, and a second curve 802a represents a second API-excipient average radial distribution function for the simulation of the API and the second excipient.

As illustrated by the graph 800a, the computing device may determine that the maximum value of each API-excipient average radial distribution function (g(r)) occurs at a radial distance (r) of about 0.5 nm. In this example, the computing device may perform the steps of block 702 to determine that the maximum value of the first API-excipient average radial distribution function is about 0.9, and the maximum value of the second API-excipient average radial distribution function is about 0.6. Thus, the computing device may determine that the maximum value of the first API-excipient average radial distribution function is greater than the maximum value of the second API-excipient average radial distribution function.

At block 704, the computing device may generate a table arranging the maximum values of the average radial distribution functions in descending order. That is, the computing device may generate the table such that the first excipient is in the first row and the second excipient is in the second row. Additionally, the computing device may identify the first excipient as the preferred test molecule at block 706, and the computing device may display the table, the graph 800a, and/or an indication of the preferred test molecule at block 410.

As an additional example. FIG. 8B is a graph 800b of API-API (i.e., reference molecule-reference molecule) average radial distribution functions for each simulation. A first curve 801b represents a first API-API average radial distribution function for the simulation of the API and the first excipient, and a second curve 802b represents a second API-API average radial distribution function for simulation of the API and the second excipient.

As indicated by the graph 800b, the computing device may determine that the maximum value of the first API-API average radial distribution function occurs at about 0.9 nm. The computing device may also determine that the maximum value of the second API-API average radial distribution function (g(r)) occurs at a radial distance (r) of about 0.4 nm. In this example, the computing device may perform the steps of block 702 to determine that the maximum value of the first API-API average radial distribution function is about 0.9, and the maximum value of the second API-API average radial distribution function is about 0.65. Thus, the computing device may determine that the maximum value of the first API-API average radial distribution function is less than the maximum value of the second API-API average radial distribution function.

At block 704, the computing device may generate a table arranging the maximum values of the average radial distribution functions in ascending order. As with the previous example, the computing device may generate the table such that the first excipient is the first row and the second excipient is in the second row. Additionally, the computing device may identify the first excipient as the preferred test molecule at block 706, and the computing device may display the table, graph 800b, and/or an indication of the preferred test molecule at block 410.

In the above examples, the computing device may include information indicative of one or more of the M probabilities of contact, one or more of the M maximum values, the table, and/or the preferred test molecule. The computing device may cause the display device to display information indicative of the simulation result, such as the table and/or the preferred test molecule, when performing the steps of block 410 of the method 400.

While the above method and examples are described with respect to a single computing device performing the methods, the steps of each method may be performed by one or more computing devices. For instance, one or more of the methods may be implemented by a distributed computing system, such as the distributed computing system 100 described with respect to FIG. 1. For instance, the computing terminal 102 may display a GUI that is configured to receive the one or more input signals. The computing terminal may then send the one or more input signals to the server device 106 via the network 104. The server device 106, upon completing the steps of the method 400, for example, may send a signal to the computing terminal 102 via the network 104 that causes a display component of the computing terminal 102 to display information indicative of the simulation result.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While the invention has been described above according to its preferred embodiments, it can be modified within the scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

1. A method comprising:
using, by a computing device, a molecular simulator to generate M sets of simulation data, wherein each of the M sets of simulation data includes one or more samples of simulation data indicative of simulated locations in a solvent of (i) molecules of a reference molecule and (ii) molecules of one of M test molecules, and wherein (a) M is a positive integer, (b) the reference molecule is an active pharmaceutical ingredient, and (c) the M test molecules are each polymeric or oligomeric excipients;
determining, for each of the M sets of simulation data, a probability of contact between a an α species and a β species to provide M probabilities of contact, wherein a contact occurs when a particle of the β species is within a range of radial distances from a particle of the α species, and wherein each of the α species and the β species are one of the reference molecule, the solvent, or one of the M test molecules;
determining a simulation result based on at least one of the M probabilities of contact; and
causing a display device to display information indicative of the simulation result.

2. The method of claim 1, further comprising: receiving, by the computing device, one or more inputs via a user interface that include information indicative of at least one of the reference molecule, the M test molecules, or the solvent.

3. The method of claim 2, wherein, to receive the M test molecules, the computing device is configured to receive via the user interface:
a selection of a polymer or oligomer;
a selection of one or more substituents; and
a selection of a location at which each of the one or more substituents is attached to the polymer or oligomer.

4. The method of claim 3, wherein the polymer or oligomer is one of polyethylene oxide, polyvinylpyrrolidone, cellulose, or cyclodextrin.

5. The method of claim 3, wherein the one or more substituents include:
one or more monomeric alkyl, acyl, or cationic groups; or
one or more polymeric or oligomeric groups that are capable of being grafted onto another polymer or oligomer.

6. The method of claim 1, further comprising, prior to generating the M sets of simulation data, using the molecular simulator to determine M sets of thermodynamic equilibrium conditions, wherein:
each of the M sets of thermodynamic equilibrium conditions includes one or more thermodynamic equilibrium conditions for a solvent system that includes the reference molecule and one of the M test molecules;
the molecular simulator uses one of the M sets of thermodynamic equilibrium conditions to generate each of the M sets of simulation data; and
a number of molecules used by the molecular simulator to determine each of the M sets of thermodynamic equilibrium conditions is less than a number of molecules used by the molecular simulator to generate each of the M sets of simulation data.

7. The method of claim 1, wherein:
the particle of the α species is one of an atom, molecule, or chemical moiety of the α species; and
the particle of the β species is one of an atom, molecule, or chemical moiety of the β species.

8. The method of claim 1, wherein determining the M probabilities of contacts comprises determining M average radial distribution functions, wherein determining each of the M average radial distribution functions comprises:
determining a radial distribution functions for each of the one or more samples of simulation data included in one of the M sets of simulation data to provide one or more radial distribution functions, wherein each of the one or more radial distribution functions is based on a number of particles of the β species that are within a range of radial distances from a particle of the α species;
normalizing each of the one or more radial distribution functions to provide one or more normalized radial distribution functions; averaging the one or more normalized radial distribution functions to provide an average radial distribution function; and determining a maximum value of each of the M average radial distribution functions to provide M maximum values, wherein each of the M maximum values is associated with one of the M test molecules.

9. The method of claim 8, wherein the simulation result includes information indicative of (i) one or more test molecules included in the M test molecules and (ii) a maximum value associated with each of the one or more test molecules.

10. The method of claim 8, further comprising:
generating a table that arranges one or more test molecules included in the M test molecules according to a maximum value associated with each of the one or more test molecules; and
causing the display device to display information indicative of the table.

11. The method of claim 8, further comprising:
identifying a preferred test molecule from the M test molecules based on the maximum value associated with each test molecule, wherein the simulated result includes information indicative of the preferred test molecule.

12. The method of claim 11, wherein the preferred test molecule is a polymer excipient included in the M test molecules associated with a lowest maximum value when the α species and the β species are the API.

13. The method of claim 11, wherein the preferred test molecule is a test molecule included in the M test molecules associated with a greatest maximum value when at least one of the α species or the β species is one of the solvent or one of the M test molecules.

14. (canceled)

15. (canceled)

16. A computing device comprising:
a processor;
a display; and
a non-transitory computer readable medium storing instructions that, when executed by the processor, cause the computing device to perform functions comprising:
generating M sets of simulation data that are each indicative of locations in a solvent of (i) instances of a reference molecule and (ii) instances of one of M test molecules, wherein (a) M is a positive integer, (b) the reference molecule is an active pharmaceutical ingredient, and (c) the M test molecules are each polymeric or oligomeric excipients;
determining, for each of the M sets of simulation data, a probability of contact between a an α species and a β species to provide M probabilities of contact, wherein a contact occurs when an instance of the β species is within a threshold distance of an instance of the α species, and wherein each of the α species and the β species are one of the reference molecule, the solvent, or one of the M test molecules;
determining a simulation result based on at least one of the M probabilities of contact; and
causing the display to display information indicative of the simulation result.

17. The computing device of claim 16, further comprising a user interface, the functions further comprising: receiving, via the user interface, one or more inputs that identify at least one of the reference molecule, the M test molecules, or the solvent.

18. The computing device of claim 16, wherein the one or more inputs identify:
a polymer or oligomer;
one or more substituents; and
a location at which each of the one or more substituents is attached to the polymer or oligomer.

19. The computing device of claim 18, wherein the polymer or oligomer is one of polyethylene oxide, polyvinylpyrrolidone, cellulose, or cyclodextrin.

20. A computing system comprising:
a processor; and
a non-transitory computer readable medium storing instructions that, when executed by the computing system, cause the computing system to perform functions comprising:
generating M sets of simulation data that are each indicative of locations in a solvent of (i) instances of a reference molecule and (ii) instances of one of M test molecules, wherein (a) M is a positive integer, (b) the reference molecule is an active pharmaceutical ingredient, and (c) the M test molecules are each polymeric or oligomeric excipients;
determining, for each of the M sets of simulation data, a probability of contact between a an α species and a β species to provide M probabilities of contact, wherein a contact occurs when an instance of the β species is within a threshold distance of an instance of the α species, and wherein each of the α species and the β species are one of the reference molecule, the solvent, or one of the M test molecules;
determining a simulation result based on at least one of the M probabilities of contact; and
providing data representing the simulation result to another computing system.

21. The computing system of claim 20, the functions further comprising:
determining M sets of thermodynamic equilibrium conditions, wherein each of the M sets of thermodynamic equilibrium conditions includes one or more thermodynamic equilibrium conditions for a solvent system that includes the reference molecule and one of the M test molecules,
wherein generating the M sets of simulation data comprises using one of the M sets of thermodynamic equilibrium conditions to generate each of the M sets of simulation data, and
wherein the M sets of thermodynamic equilibrium conditions are determined using less molecules than are used to generate each of the M sets of simulation data.

22. The computing system of claim 20,
wherein the instance of the α species is one of an atom, molecule, or chemical moiety of the α species, and
wherein the instance of the β species is one of an atom, molecule, or chemical moiety of the β species.
